(19) United States
(12) Patent Application Publication
(10) Pub. No.: US 2015/0089875 A1
(43) Pub. Date: Apr. 2, 2015

(54) Hardware for opening a frameless window into laterally displaced parallel positions

(71) Applicant: Roger Malmrose, Pleasanton, CA (US)

(72) Inventor: Roger Malmrose, Pleasanton, CA (US)

(21) Appl. No.: 14/039,194

(22) Filed: Sep. 27, 2013

(51) Int. Cl. E06B 3/46; E06B 9/52; E05F 11/48; E05B 65/08; E05F 11/38

(52) U.S. Cl. CPC E06B 3/4627; E05B 65/08; E05F 11/385; E05F 11/483; E06B 9/521
USPC 49/130; 49/414; 49/352; 49/449

(57) ABSTRACT

A window pane is mounted in a closed position outside a window frame, commonly referred to as a frameless window, and is movable into open positions parallel to the closed position. The window pane can be slid into a fully open position. Sliding mechanisms are attached to the window pane. Swing arms connect the sliding mechanisms to the window frame. Control arms also connect the sliding mechanisms to the window frame. They determine the distance of and control the translation of the window pan from the closed position to the initial open position. A handle is attached to at least one of the sliding mechanisms or window pane. Latching mechanisms secure the handle in the open positions. The invention is designed so that a plurality of screens allows air flow through the window frame, preventing passage of insects or debris through the window frame.

### CROSS-REFERENCE TO RELATED APPLICATIONS

Not Applicable.

### BACKGROUND OF THE INVENTION

This invention relates to opening frameless windows, used in recreational vehicles, trailers, trucks, boats, and the like, in a position basically parallel orientation to the window frame. Prior art is limited to methods for opening windows which are attached to the window frame by some form of a hinge.

The Field of Search is contained within U.S. Patent Class 49, Movable or Removable Closures, and more specifically the following subclasses: 49/219, 49/221, 49/212, 49/127, 49/128, 49/129, 49/130, 49/209, 49/210, 49/248, 49/193, and 49/252.

The following references are cited:

U.S. Pat. No. 3,841,024, October 1974, Cheng
U.S. Pat. No. 4,042,004, August 1977, Kwan
U.S. Pat. No. 4,551,945, November 1985, von Resch

### BRIEF SUMMARY OF THE INVENTION

This invention relates to fully opening frameless windows, used in recreational vehicles, trailers, trucks, boats, and the like, which will hereinafter be referred to as a vehicle. Current frameless windows have the disadvantage that they cannot be fully opened. They are designed to only partially open, pivoting on a hinge along one edge of the glass pane which is attached directly to a window frame attached to the vehicle, as illustrated in von Resch, U.S. Pat. No. 4,551,945. Current frameless window designs allow for only minimal airflow through the window frame. The current designs for opening frameless windows could be modified to allow the window pane to swing open more fully; however, this method of opening frameless windows results in the window pane being rotated toward a perpendicular position compared to the window frame, causing the window pane to extend far outside the plane defined by the window frame.

This invention is directed to hardware for a frameless window so that the window pane can be displaced to allow for full air flow through the window frame, with the window pane being in a parallel position to the window frame. A window pane is translated from a first, closed position into a second, open position, and then slid into a third, open position with the movement being effected by swing arms, control arms, sliding mechanisms, handles, and latching mechanisms. In each position, this invention holds the window pane securely so that an external force, such as wind or manual exertion, against the glass pane can move it to another position. This invention can be used with a frameless window assembly with a single window pane or with a frameless window assembly composed of a plurality of window panes which may be fixed or movable. If this invention is applied to a single window pane, all or part of the window pane may extend outside the window frame over the vehicle wall when open to fully open the air passage through the window frame. If this invention is applied to a frameless window assembly composed of a plurality of panes, the window panes to which the invention is applied may be opened either over the vehicle wall or over other panes in the window assembly. This invention also allows for restricted air flow through the window frame by not fully opening the window pane. This invention applies to a flat or curved glass pane, as well as a flat or curved vehicle wall. Most window panes are composed of glass, and will be hereinafter referred to as glass panes to minimize potential confusion with reference to window frames, although the window pane may be composed of other materials such as polycarbonate.

In the preferred embodiment of this invention, two sets of hardware are used on each glass pane. The sets of hardware function symmetrically, providing for parallel sliding mechanisms which allow the glass pane to move in a lateral direction while being supported on two sides. Most applications of this invention will be designed for horizontal sliding of the glass pane, which would mean that the hardware would typically be located on the top and bottom of the window frame. In alternative embodiments of this invention, the glass pane will move in any direction along the line of the parallel sliding mechanisms. In such embodiments, it may be advisable to install counter weights to facilitate lifting or supporting of the glass pane.

In the preferred embodiment of this invention, sliding mechanisms are attached to the glass pane either mechanically or with adhesive. Sliding mechanisms are telescopic in nature and can be composed of two or more parts, allowing various distances of extension when the sliding mechanisms are extended from their retracted state. One part of the sliding mechanism is attached to the glass pane, while another part of the sliding mechanism is attached to the swing arms and control arms which are attached to the window frame. This attachment method secures this part of the sliding mechanism so that it may be moved only between the first and the second positions. The glass pane can then be slid from the second position to the third position as the telescopic sliding mechanisms are extended.

One advantage of this invention is its simple and inexpensive method of holding the glass pane securely. In the preferred embodiment of this invention, swing arms must be long enough to allow for the sliding mechanisms and glass pane to be translated from the first to second positions with the swing arms being rotated toward 90 degrees from the plane of the window frame. The swing arms are used to support the weight of the glass pan and sliding mechanisms from the window frame, and the translation distance must be sufficient to allow the sliding mechanism and glass pane to extend outside the window frame and over the exterior vehicle wall or over an adjacent glass pane. As the swing arms pivot about their attachment points to the window frame, the sliding mechanisms and glass pane move in both a parallel translation and lateral direction. It is necessary, therefore, that the sliding mechanisms be placed sufficiently far from the window frame to allow for lateral movement of the sliding mechanisms without interference from the window frame. The translation distance can be calculated by multiplying the length of the swing arm by the trigonometric value of sin THETA, where THETA is the angle between the window frame and the swing arm. THETA must be less than 90 degrees, and the longer the swing arm, the greater the translation distance when THETA is small. The translation distance from the first or closed position to the second position is calculated by the length of the swing arm times the value of sin THETA second position minus sin THETA first or closed position. The translation distance must exceed the distance needed so that the sliding mechanism can extend into the third position without interference from the vehicle wall or other glass pane. The lateral displacement when moving from the first or closed position to the second position is calculated by the length of the swing arm times the value of cos THETA first minus cos THETA second position. The sliding mechanism must be placed far enough away from the window frame so that it may be moved into the second position without interference from the window frame. The lateral displacement is smaller when THETAs are smaller. In an alternative embodiment of this invention, telescopic arms could be used in place of the swing arms. In such an alternative embodiment of this invention, the glass pane would not experience a lateral displacement when moving from the first or closed position to the second position.

If the dimension of the window frame is small, the swing arms can be curved rather than straight to effect the necessary transition from first to second position. Furthermore, the control arms may overlap the swing arms.

One advantage of this invention is its simple and inexpensive mechanism for holding the sliding mechanism securely in second position. In the preferred embodiment of this invention, one or two control arms attach the window frame to a control arm sliding rail which is attached to the part of the sliding mechanism that remains in the second position. The control arms are manually manipulated to extend or retract the glass pane between the first or closed position and the second position. The control arm manipulation mechanism causes the control arms to extend and retract the glass pane. A control arm mechanism with two control arms would function with a scissor-type movement. Movement of the control arms is similar in motion to the swing arms. In the preferred embodiment of this invention, a stopping block is attached within the control arm rail to specify the distance of translation of the sliding mechanisms from the first or closed position to the second position. Alternatively, other methods of stopping the control arm extension, such as insertion of a pin or a deformation in the control arm sliding rail, could similarly control and determine the distance of translation of the sliding mechanisms from the first or closed position to the second position. Because the sliding mechanisms and glass pane experience lateral displacement during the movement from the first or closed position to second position, the location of the control arm rail on the sliding mechanism, as well as the stopping block within the control arm rail, must be considered to allow for proper functioning of the control arms during the lateral displacement of the glass pane. The control arm rail must also move from the first to second position without interference from the window frame. In the preferred embodiment of this invention, the control arm manipulation mechanism is operated manually to move the glass pane from first or closed position to second position, and then back to first or closed position. In an alternative embodiment of this invention, a mechanism such as a control cable or push rod which translates the glass pane from the first to second position could be used instead of control arms. In another alternative embodiment of this invention, a locking arm or mechanism could be attached to a swing arm. In another alternative embodiment of this invention, an electronic assembly could be used to manipulate the control arms. In alternative embodiments of this invention, electronic or mechanical gearing, cables, or other means could be used to move the glass pane from second and third positions. The preferred embodiment presented herein provides an inexpensive means of opening and closing the glass pane.

One advantage of this invention is the capability to hold the glass securely in not only the first or closed position, but also both second and third positions. In the preferred embodiment of this invention, a handle is attached to the part of the sliding mechanism which is attached to the glass pane on at least one of the two parallel sliding mechanisms. The handle is long enough to be accessible from inside the vehicle in which the window frame is installed when the glass pane is translated from first to second position. A third position latching mechanism secures the handle when the glass pane is in the second position. In the preferred embodiment of this invention, because of the lateral translation from going between the first and second positions, one side of the handle is contoured so that the edge of the handle remains close to the edge of the third position latching mechanism when moving between first and second positions. This allows the glass pane to remain secure during movement between first and second positions, allowing the glass pane to be only partially opened if limited airflow through the window frame is desired. The glass pane can remain in the second position and allow for modest air flow, but not the full air flow available when the window is opened in the third position. In the preferred embodiment of this invention, in order for the glass pane to be slid from the second to the third position, the third position latching mechanism must be manually opened to allow the handle to be slid from the second position to the third position. When the handle is slid to the third position, it is held in place by a third position latching mechanism. With the glass pane in the third position, the window is fully opened, allowing the free flow of air through the window frame. In the preferred embodiment of this invention, the third position latch must be manually opened to allow the handle to slide back to the third position latching mechanism. In an alternative embodiment of the invention, the sliding mechanism may contain features which hold the glass pane in the second and third positions. However, exterior forces from outside the vehicle can unintentionally and more easily move the glass pane from its position.

Another advantage of this invention is the control of movement from first or closed position to second position, and then from second position to third position. Similar control is in place for the reverse sequence of movements from third position to second position, and then from second position to first or closed position. The first step in opening the frameless window must be manual manipulation of the control arms to effect the translation of the glass pane from first or closed position to second position. In other words, it is not possible to make a lateral translation directly from first or closed position to third position since the glass pane is held securely to the window frame while in first or closed position. Once the glass pane is in the second position, it can then be moved to either the first or third position. In order to prevent an attempt to move the glass pane from the third position directly to the first or closed position by manually manipulating the control arms, which could damage the exterior vehicle wall, the handle is notched so that the third position latching mechanism prevents the translation of the glass pane to the first or closed position. An attempt to retract the control arms while the glass pane is in the third positions fails. The window will thus be moved to the second position before it is moved back to the first or closed position.

With the exception of an opening to allow the handle to slide from second to third position, the preferred embodiment of this invention provides for screens to cover the entire window frame, preventing passage of insects or debris into the vehicle. Screen assemblies cover the hardware which is used to move the glass pane between first and second positions. The remaining area of the window frame is covered by a screen. Because the handle is used to slide the glass pane from second to third position, in the preferred embodiment of this invention, the edges of the screens between which the handle passes have brush strips which allow the handle to slide between them, while preventing passage of insects or debris through the brush strips. In alternative embodiments of this invention, other materials such as rubber or plastic extrusions could be used to allow handle movement and prevent passage of insects or debris through the handle sliding area.

### BRIEF DESCRIPTION OF THE SEVERAL VIEWS OF THE DRAWING

FIG. 1 is an enlarged vertical sectional view of the invention in the first or closed position taken along line II-II of FIG. 4.

FIG. 2 is an enlarged vertical sectional view of the invention in the second position taken along the along line II-II of FIG. 4.

FIG. 3 is an elevation view of a glass pane opened outside a window frame in the third position provided with the hardware embodying the present invention, attached to the top and bottom of the window frame, and top and bottom of the glass pane, to allow the window to reside outside the window frame.

FIG. 4 is an elevation of the opposite side of FIG. 3 with the glass pane in the first or closed position as would be visible by a person inside a vehicle in which the present invention is installed.

FIG. 5 is a horizontal sectional view of the invention in the first or closed position taken along the lines III-III of FIG. 4.

FIG. 6 is a horizontal sectional view of the invention in the second position, based on the horizontal sectional view of FIG. 5.

FIG. 7 is a horizontal sectional view of the invention in the third position, based on the horizontal sectional view of FIG. 5.

FIG. 8 is an elevation view of the handle 65.

FIG. 9 is an elevation view of the controller arm assembly in the first or closed position.

FIG. 10 is an elevation view of the controller arm assembly in the second and third positions.

FIG. 11 is a top view of the swing arm assembly.

FIG. 12 is an elevation view of the swing arm assembly.

### DETAILED DESCRIPTION OF THE INVENTION

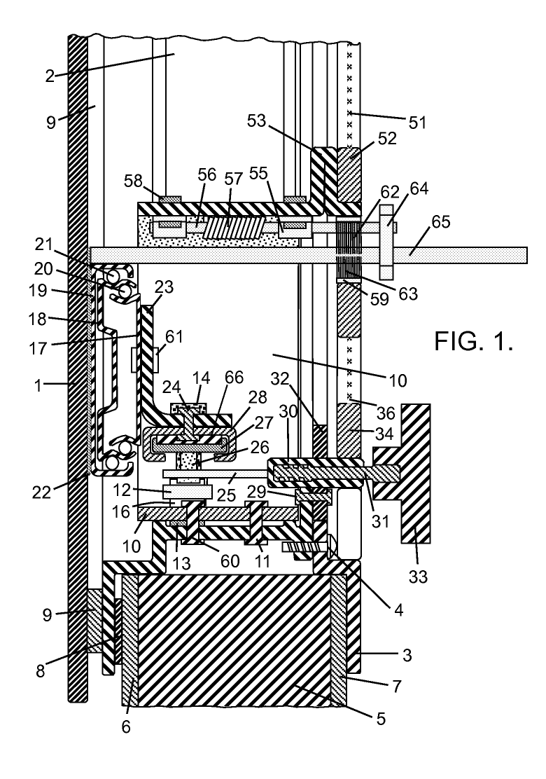

In FIG. 1, in the first or closed position, glass pane 1 is located outside of exterior window frame 2. Glass pane 1 is generally constructed of glass, but may be constructed of other materials including polycarbonate. Exterior window frame 2 is commonly constructed of aluminum, but may be constructed of other materials including vinyl and plastic. Exterior window frame 2 is inserted into the vehicle wall 5. Interior window frame 3 is also inserted into the vehicle wall 5. Interior window frame 3 is generally composed of the same material as exterior window frame 2, but may be composed of another material. Vehicle wall 5 is typically composed of wood, but may be composed of other materials. The exterior of vehicle wall 5 is typically covered by exterior vehicle wall surface 6 is typically composed of fiberglass or aluminum siding, but may be composed of other materials. The interior of vehicle wall 5 is covered by interior vehicle wall surface 7, which is typically composed of wood paneling, but could be composed of other materials. Exterior window frame 2 and interior window frame 3 are attached together with screws 4, but could be attached together using other attachment technologies such as rivets.

When exterior window frame 2 is installed into vehicle wall 5, putty 8 is placed between the exterior window frame 2 and the exterior vehicle wall surface 6 to provide a seal which prevents intrusion of water, insects, wind and other items from passing through the gap between exterior window frame 2 and the exterior vehicle wall surface 6. The material used for putty 8 may be substituted by other materials including silicone or rubber.

In the first or closed position, glass pane 1 is pressed against window seal 9. Window seal 9 provides a seal between glass pane 1 and the exterior window frame 2 to prevent water, insects, wind, and other items from passing through the gap between glass pane 1 and exterior window frame 2.

Lower perimeter controller frame 10 is attached to exterior window frame 2 using various rivets 11, 60. Different types of attachment technologies may be used, such as welding or screws. Lower perimeter controller frame 10 is made of stainless steel or another strong material. In cases where exterior window frame 2 is composed of a highly durable material, it is possible to eliminate lower perimeter controller frame 10. However, in cases where exterior window frame 10 is composed of a softer material, such as plastic, perimeter controller frame 10 is necessary.

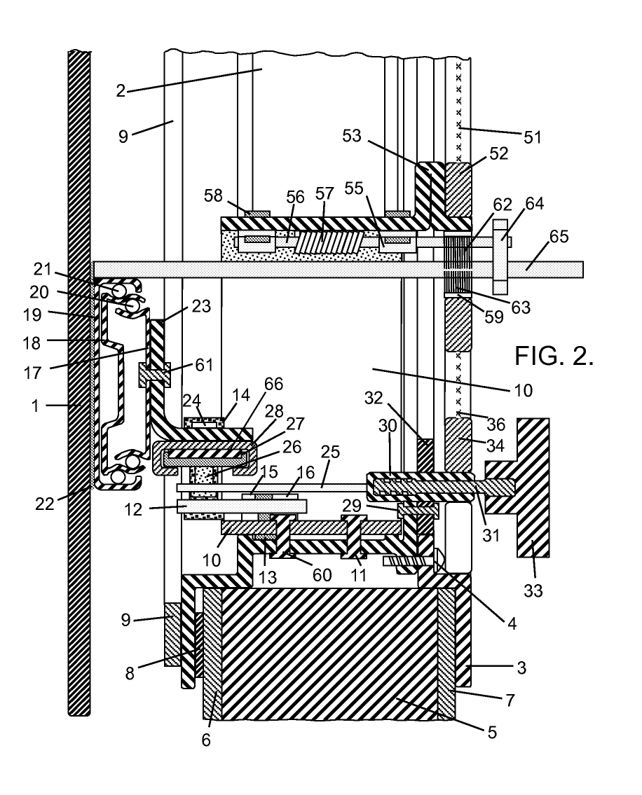

Swing arm 12 is attached to lower perimeter controller frame 10 by swing arm rotation rivet 13. FIG. 11 shows a top view of swing arm 12 and swing arm rotation rivet 13, and FIG. 12 shows the corresponding side view. Swing arm rotation rivet 13 is the single point of attachment of swing arm 12 to lower perimeter controller frame 10. Swing arm rotational rivet 13 provides a standoff distance between swing arm 12 and lower perimeter controller frame 10. A swing arm standoff is attached to swing arm 12 on each side of swing arm rotation rivet 13. Exterior swing arm standoff 15 and interior swing arm standoff 16 are dimensioned so that the distance between swing arm 12 and lower perimeter controller frame 10 is the same as the distance defined by the standoff distance of swing arm rotational rivet 13. With the swing arm 12 being parallel to lower perimeter controller frame 10 because of the equal standoff distances of exterior swing arm standoff 15, interior swing arm standoff 16, and swing arm rotation rivet 13, swing arm 12 is able to rotate only side to side in a parallel plane to lower perimeter controller frame 10 around swing arm rotation rivet 13. Swing arm 12 is not able to significantly move up and down in a perpendicular movement to lower perimeter controller frame 10. FIG. 2 shows swing arm 12 in a rotated position.

A sliding mechanism composed of an exterior sliding mechanism 19, center sliding mechanism 18, and interior sliding mechanism 17 is attached to glass pane 1. The sliding mechanism is similar to that used as drawer slides and can be composed of at least two pieces. In this invention, the sliding mechanism is defined with three pieces. The sliding mechanism construction functions with the use of ball bearings. Exterior ball bearings 21 allow a sliding movement between exterior sliding mechanism 19 and center sliding mechanism 18, and interior ball bearings 20 allow a sliding movement between center sliding mechanism 18 and interior sliding mechanism 17. Exterior sliding mechanism 19 is attached directly to glass pane 1 through adhesive 22. A common brand of adhesive 22 for such an invention is manufactured by Sika. Exterior sliding mechanism 19 could also be attached to glass pane 1 by other means such as bolts.

Interior sliding mechanism 17 is attached to sliding mechanism bracket 23 through the use of rivets 61. Other means of attachment such as adhesive or bolts could be used. Sliding mechanism bracket 23 is attached to swing arm 12 through slider bracket rotation rivet 14. A top view of sliding mechanism bracket rotation rivet 14 is illustrated in FIG. 11, with a side view being illustrated in FIG. 12.

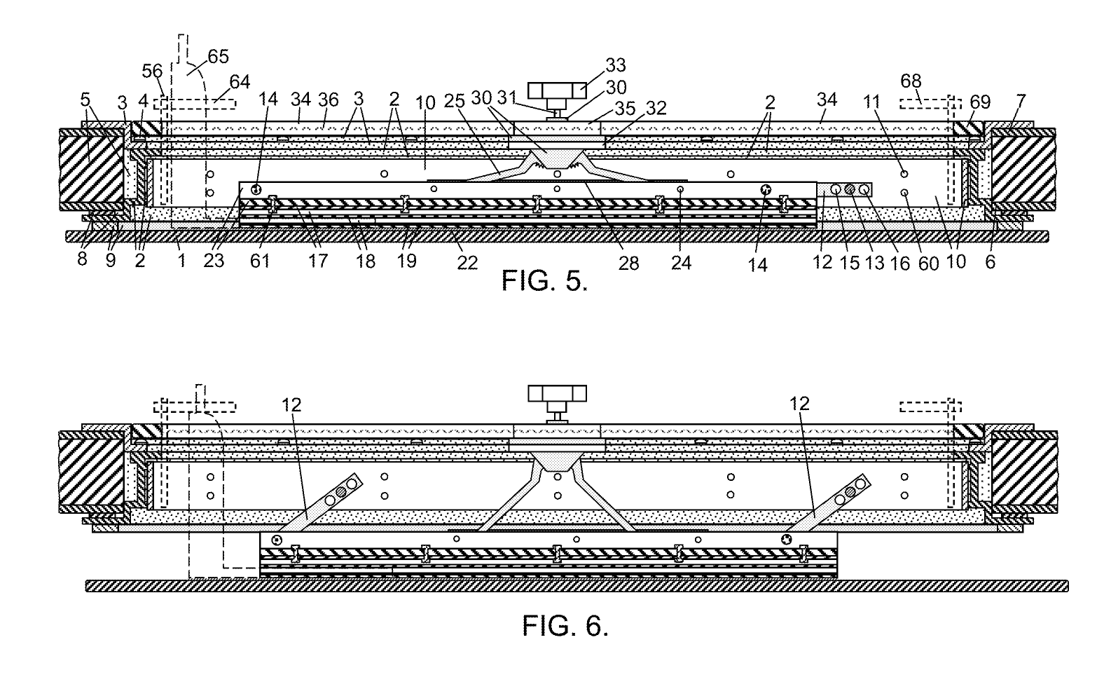

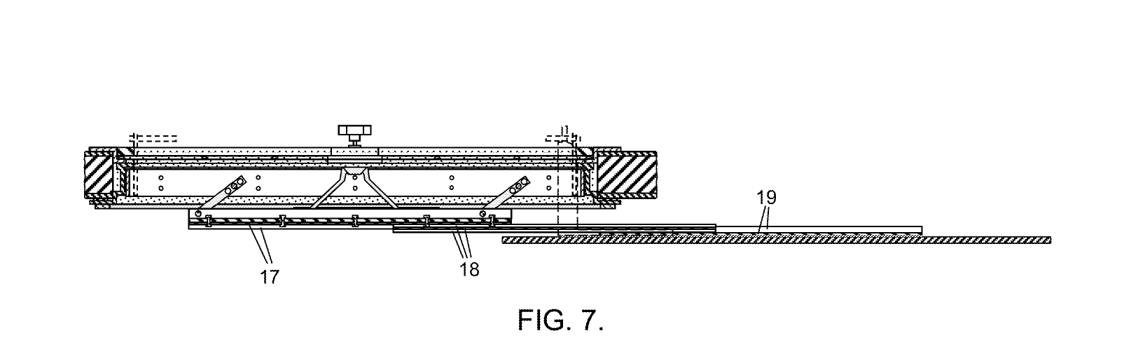

In this invention, at least two slide arms 12 are attached to sliding mechanism bracket 23. FIG. 6 and FIG. 7 show two slide arms 12 in a rotated position. One of the two slide arms 12 is shown in FIG. 5 in a non-rotated position; the other is covered by sliding mechanism bracket 23. When sliding mechanism bracket 23 is in the rotated position, as shown in FIG. 6 and FIG. 7, sliding mechanism bracket 23 has been moved laterally in the direction of rotation. Rivets 61 is not shown as a cross section in FIG. 1 when in the non-rotated position, as it is off the cross section line, but moves into the cross section line in the rotated position as illustrated in FIG. 2. FIG. 6 illustrates that rotation of the slide arms 12 causes glass pane 1 to be extended outside exterior window frame 2 in a position parallel to exterior window frame 2.

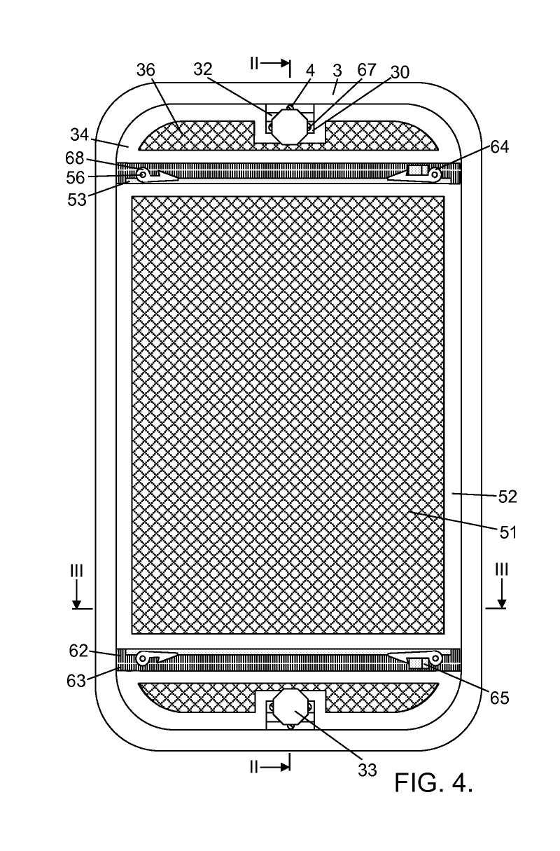

Referring to FIG. 4, controller arm housing 30 is attached to housing attachment plate 32 with housing screws 67. Housing screws 67 are shown in FIG. 4, partially covered by control arm handle 33. In the current invention, housing attachment plate 32 is attached to exterior window frame 2 with rivets 29. Other attachment technologies such as screws could be used instead of rivets 29. In other embodiments of this invention, controller arm housing 30 could be attached directly to exterior window frame 2 or interior window frame 3. Use of the housing attachment plate 32 allows for less product cost as the flange the exterior window frame 2 or interior window frame 3 to which attachment plate 32 would be attached, would need to be larger than illustrated in the current embodiment. Controller arm 25 is attached to controller arm housing 30 and can be extended or retracted by turning the controller arm screw 31 which has gears to cause movement of controller arm 25. Controller arm screw 31 is turned by clockwise or counter-clockwise movement of control arm handle 33 to which it is connected. In the current embodiment of this invention, two controller arms 25 are attached to controller arm housing 30. This is a common scissor-like design. Single controller arms 25 can also be used. FIG. 5 and FIG. 9 show views of controller arms 25 in the first or closed position. FIG. 6 and FIG. 10 show views of controller arms in an extended position.

At the end of controller arms 25 is a controller arm wheel 27, which is attached to controller arms 25 by a controller arm wheel standoff 26. Controller arm wheel 27 is located inside a controller arm wheel rail 28 which allows movement of controller arm wheel 27 inside controller arm wheel rail 28. Controller arm wheel rail 28 is attached to sliding mechanism bracket 23 by use of rivets 24. Alternative attachment technologies could be used. In the current embodiment, rivet 24 is located on the cross section line as illustrated in FIG. 1. Because of the lateral movement of sliding mechanism bracket caused when swing arms 12 are rotated outward, rivets 24 are no longer along the cross section line as illustrated in FIG. 2.

A controller arm stopping block 66 is secured inside controller arm wheel rail 28 to prevent over extension of controller arms 25 and secure glass pane in second position. FIG. 9 and FIG. 10 illustrate that the controller arm stopping block 66 must be offset within the controller arm wheel rail 28 to allow for lateral displacement of glass pane 1 caused by the rotation of swing arms 12.

In the first or closed position, glass pane 1 is securely held closed by the controller arms 25 as illustrated in FIG. 1 and FIG. 5. Controller arms 25 also hold glass pane 1 securely when it is extended outside exterior window frame 2 when controller arms 25 are in an extended position as illustrated in FIG. 2 and FIG. 6. In this second position as illustrated in FIG. 2 and FIG. 6, air is allowed to enter through the gap formed between glass pane 1 and exterior window frame 2.

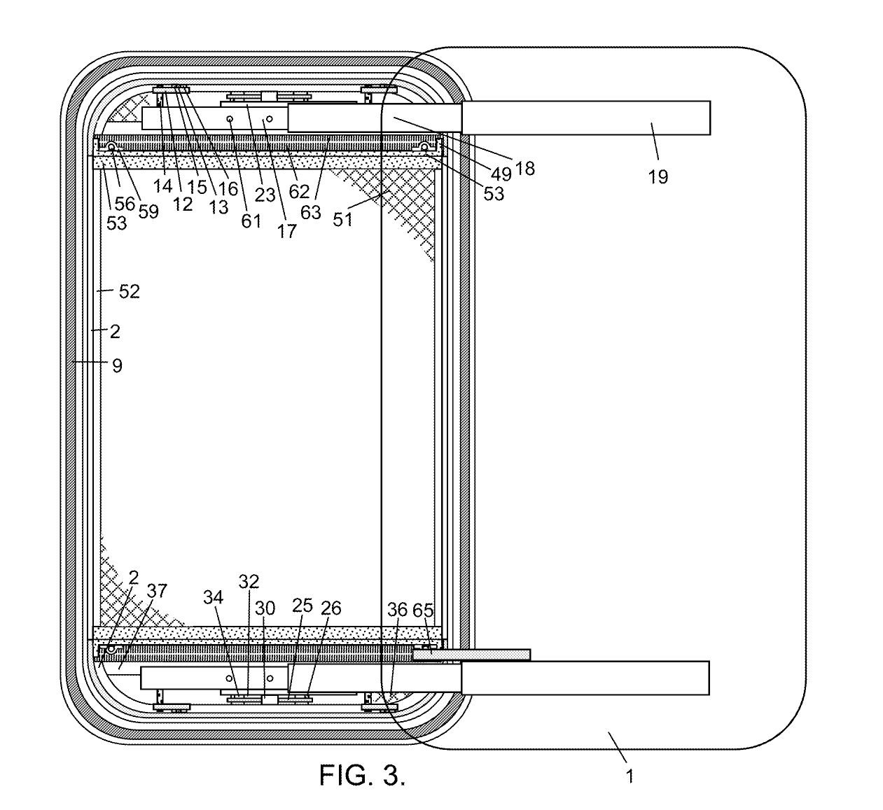

FIG. 3 and FIG. 7 show glass pane 1 in the third position, extended outside exterior window frame 2 and over vehicle wall 5, which allows a fully opened window and free flow of air through the window frame. Because of their telescopic nature, exterior sliding mechanism 19 and center sliding mechanism 18 are extended laterally, with exterior sliding mechanism 19 overlapping center sliding mechanism 18, and center sliding mechanism 18 overlapping interior sliding mechanism 17. Interior sliding mechanism 17 remains stable in the second position.

In the preferred embodiment, sliding handle 65 is attached to glass pane 1 by adhesive 22, but could also be attached using bolts or other technologies. Sliding handle 65 has two functions. First, it is used to slide glass pane 1 from the second position to the third position, and second, it holds glass pane 1 securely in the first and third positions. As shown in FIG. 1, FIG. 2, and FIG. 4, sliding handle 65 is held by first or closed position latch 64. The entire latch assembly is a common technology and is essentially composed of latch rod 56 and latch spring 57, which are held to upper perimeter controller frame 53 by latch clamps 55. Rivets 58 attach latch clamps 55 to upper perimeter controller frame 53, but other technologies such as bolts could be used.

In the preferred embodiment, upper perimeter controller frame 53 is made of the same material as lower perimeter controller frame 10. It must be strong and not subject to significant deformation.

Latch spring 57 holds the first or closed position latch 64 in a closed position, which can be manually opened to allow movement of sliding handle 65 from the second position to the third position, and from third position back to second position. FIG. 4 and FIG. 5 show sliding handle 65 in the first or closed position. FIG. 6 shows sliding handle 65 in the second position, and FIG. 7 shows sliding handle 65 in the third position.

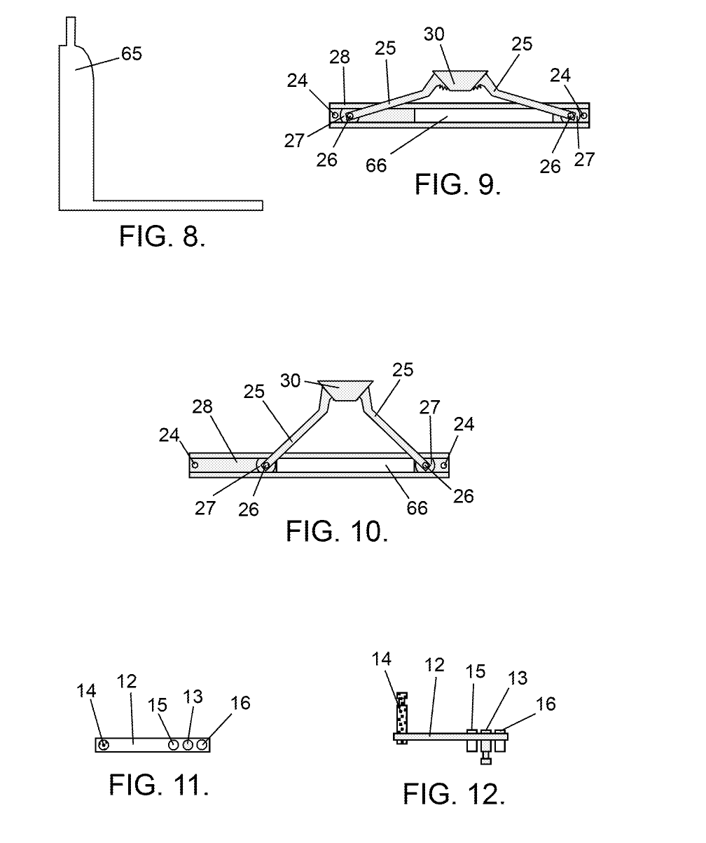

Sliding handle 65 is designed to ensure that glass pane 1 is held securely when glass pane 1 is moving between first or closed position and second position. FIG. 8 shows the contour of sliding handle 65 designed by calculating the lateral and outward movement as the swing arms 12 rotate while glass pane 1 moves from first or closed position to second position. The contour of sliding handle 65 is determined by the length of sliding handle 65, and the sine and cosine of the angle of sliding handle 65 against lower perimeter controller frame 10. When glass pane 1 moves from first or closed position to second position, the contoured edge of sliding handle 65 remains against the hooked edge of first or closed position latch 64. This prevents glass pane 1 from sliding out of position and potentially damaging vehicle wall 5 as glass pane 1 transitions between first or closed position and second position.

To move glass pane 1 from second position to third position, first or closed position latch 64 is manually rotated to release sliding handle 65 which can now be moved laterally toward third position latch 68. Third position latch 68 is designed so that sliding handle 65 is automatically secured by third position latch when moved to third position.

As shown in FIG. 1 and FIG. 2, upper perimeter controller frame 53 is bent to provide two functions. First, the bends in upper perimeter controller frame 53 provides strength and rigidity. Upper perimeter controller frame 53 spans the entire length of the window opening as shown in FIG. 3, and has the first or closed position latch 64 and third position latch 68 attached to it as shown in FIG. 4. Manual movements of these latches requires that upper perimeter controller frame 53 have adequate strength. Second, the bend in upper perimeter controller frame 53 provides an overlap and resting place for center screen frame 52.

Prevention of insects and debris from passing through the invention is essential. Because sliding handle 65 must be free to move between second and third positions, it is necessary to provide a barrier. In the preferred embodiment, sliding handle 65 passes between upper brush 62 and lower brush 63. As illustrated in FIG. 1 and FIG. 2, upper brush is attached to upper perimeter controller frame 53 with an adhesive 55. Lower brush 63 is attached to controller screen frame 37 with an adhesive 59. FIG. 3 and FIG. 4 show upper brush 62 and lower brush 63 spanning the length of the upper perimeter controller frame 53 to allow sliding handle 65 to fully open glass pane 1.

Controller screen 36 prevents insects and debris from passing through the invention. FIG. 4 shows controller screen 36 secured by controller screen frame 34, which completely outlines the perimeter. Controller screen 34 may be held securely in place by using clips or other means. In the present embodiment, controller screen is designed to cover screws 4 to provide a better cosmetic view.

Center screen 51 is secured by center screen frame 52, which completely outlines the perimeter defined by the sides of interior window frame 3 and upper perimeter controller frame 53. FIG. 4 shows the entire window assembly protected by screen. Center screen frame 52 would typically be attached to interior window frame 3 and upper perimeter controller frame 53 with the same technology used to attach controller screen frame 34.

For further clarification of FIG. 1 and FIG. 2, additional parts are labeled.

FIG. 3 and FIG. 4 show the complete window assembly, with the controlling mechanisms located on the top and bottom of the window assembly, providing a complete sealing of glass pane 1 to exterior window frame 2. In alternative embodiments, the orientation of the opening of glass pane 1 could necessitate that the controlling mechanisms be located on other orientations of a window assembly, allowing glass pane 1 to open in non-horizontal directions.

1. Apparatus for a window comprising:
a window frame assembly,
a window pane, and
hardware engaged with said window frame assembly and said window pane for translating said window pane between a first closed position and an open second position parallel to the first closed position outside said window frame, and for laterally displacing said window pane between said open second position and an open third position,
said hardware comprising:
one or more sliding mechanisms coupled to said window pane to laterally slide said window pane between said open second position and said open third position,
means for translating said window pane to and from said first closed position and said open second position, comprising swing arms for securing said one or more sliding mechanism to said window frame and supporting said window pane, and control arms for extending and retracting said sliding mechanisms, said control arms being configured to retain said one or more sliding mechanisms in said open second position and establishing a determined distance of parallel translation from said first or closed position to said open second position;
a handle for sliding said window pane between said open second position and said open third position, and
a screen to prevent passage of insects and other debris through said window frame, said screen comprising a slot through which said handle passes, to allow said handle to slide between said open second position and said open third position.

2. Apparatus, as set forth in claim 1, wherein said window frame assembly a further fixed window pane.

3. (canceled)

4. Apparatus, as set forth in claim 1, wherein said one or more sliding mechanisms are telescopic, allowing said window pane to extend to and from said open second position and said open third position.

5. Apparatus, as set forth in claim 1, 2, or 4, wherein said swing arms are pivotally secured to said window frame assembly and said one or more sliding mechanisms, said swing arms being disposed in spaced relation to said one or more sliding mechanisms and said window frame, said swing arms when extended in said open second position being at an angle less than 90 degrees to said window frame, said angle and a length of said swing arms allowing sufficient translated distance from said first or closed position to said open second position to allow said one or more slide mechanisms and said window pane to extend over an exterior vehicle wall.

6. Apparatus, as set forth in claim 1 or 2, wherein said control arms are coupled to control arm rails which are coupled to said one or more sliding mechanisms, said control arm rails containing a blocking mechanism to limit the amount of translation possible from said first or closed position to said open second position.

7. Apparatus, as set forth in claim 1, wherein said control arms are comprised of control cables, push rods, or telescoping means to control the amount of translation from said closed first or closed position to said open second position.

8. Apparatus, as set forth in claim 1, comprising latching mechanisms including a second open position latching mechanism and a third open position latching mechanism, the second open position latching mechanism being configured to contact one edge of said handle, wherein said one edge is contoured to engage said latching mechanism when translating said window pane to and from said first closed position and said open second position, and the third open position latching mechanism configured to contact another edge of said handle to prevent translation of said glass pane toward said first closed position when window pane is in said open third position.

9. Apparatus, as set forth in claim 8, wherein said latching mechanisms require release to allow for movement of said handle to and from said open second position and said open third position.

10. Apparatus, as set forth in claim 1, wherein said slot which allows said handle to travel to and from said open second position and said open third position is protected by a brush to prevent passage of insects and debris through said window frame assembly.

11. Apparatus, as set forth in claim 1, wherein said swing arms are curved.

12. Apparatus, as set forth in claim 1 or 10, wherein window frame assembly comprises a framework which is bent or extruded to provide rigidity and to provide for insertion of said screen for preventing passage of insects and debris though said window frame assembly.

13. Apparatus, as set forth in claim 1, 4, 8, or 9, wherein said one or more sliding mechanisms contain stops to determine the total length of distance the window pane can travel.

14. Apparatus as set forth in claim 8, wherein said latching mechanisms comprise means for biasing said latching assemblies in a closed position to retain said handle securely.

15. (canceled)

16. Apparatus as set forth in claim 1, wherein said one or more sliding mechanisms comprise stops to allow window pane to be held securely at a plurality of locations along a distance through which the window pane can travel.

17. A frameless window assembly comprising:
a window pane;
means coupled to the window pane for securing the window pane such that in at least one position one or more edges of the window pane are visible; and
an opening mechanism comprising at least one telescoping slide coupled to the window pane whereby the window pane is extended outward and slides between a sliding closed position and a sliding open position.
